(19) United States
(12) Patent Application Publication
(10) Pub. No.: US 2026/0204254 A1
(43) Pub. Date: Jul. 16, 2026

(54) ELECTRONIC DEVICE FOR PERFORMING PROMPT TUNING AND CONTROL METHOD THEREOF

(71) Applicant: SAMSUNG ELECTRONICS CO., LTD., Suwon-si (KR)

(72) Inventor: Jonggu KIM, Suwon-si (KR)

(73) Assignee: SAMSUNG ELECTRONICS CO., LTD., Suwon-si (KR)

(21) Appl. No.: 19/563,355

(22) Filed: Mar. 11, 2026

Related U.S. Application Data
(63) Continuation of application No. PCT/KR2024/019407, filed on Nov. 29, 2024.

(30) Foreign Application Priority Data
Dec. 29, 2023 (KR) 10-2023-0196616

(51) Int. Cl. G10L 15/183; G06F 3/0482; G10L 15/22

(52) U.S. Cl. CPC G10L 15/183; G10L 15/22; G06F 3/0482; G10L 2015/223

(57) ABSTRACT

An electronic device includes memory storing instructions; and one or more processors comprising processing circuity. The instructions, when executed by the one or more processors individually or collectively, cause the electronic device to identify a user command based on a user utterance voice stored in the memory, obtain a first word indicating a location of at least one word that is a target of the user command based on the user utterance voice, obtain, based on a predetermined word being identified from the user utterance voice, a second word explaining the predetermined word, and obtain a prompt to be input to a large language model (LLM) based on the user utterance voice, the first word, and the second word.

### CROSS-REFERENCE TO RELATED APPLICATIONS

This application is a bypass continuation application of International Patent Application No. PCT/KR2024/019407, filed on Nov. 29, 2024, which claims priority to and is based on Korean Patent Application No. 10-2023-0196616, filed on Dec. 29, 2023, the disclosures of which are incorporated herein in their entireties by reference.

### BACKGROUND

### 1. Field

This disclosure relates to an electronic device and a control method thereof, and particularly to, an electronic device performing prompt tuning and a control method thereof.

### 2. Description of Related Art

Electronic devices using a large language model (LLM) may include learnable parameters that capture linguistic patterns and relationships between words. However, the accuracy of the output of the LLMs may depend on the prompt, leading to inconsistent outputs generated by the LLM. The accuracy of the outputs of the LLM can be improved.

### SUMMARY

According to an aspect of one or more embodiments of the present disclosure, an electronic device may include memory storing instructions; and one or more processors including processing circuitry. The instructions, when executed by the one or more processors individually or collectively, may cause the electronic device to identify a user command based on a user utterance voice stored in the memory; obtain a first word indicating a location of at least one word that is a target of the user command based on the user utterance voice; obtain, based on a predetermined word being identified from the user utterance voice, a second word explaining the predetermined word; and obtain a prompt to be input to a large language model (LLM) based on the user utterance voice, the first word, and the second word.

The memory may further store the LLM. The instructions, when executed by the one or more processors individually or collectively, may further cause the electronic device to input the prompt to the LLM; and obtain response information corresponding to the prompt.

The instructions, when executed by the one or more processors individually or collectively, may further cause the electronic device to identify a word having multiple meanings as the predetermined word based on the user utterance voice; and obtain, among the multiple meanings, the second word meant by the predetermined word in the user utterance voice.

The electronic device may include a display. The instructions, when executed by the one or more processors individually or collectively, may further cause the electronic device to control a display to display a user interface (UI) for selecting one of the multiple meanings; and obtain, based on a selection of one of the multiple meanings, the second word.

The memory may further store a score indicating user satisfaction with a plurality of words and the second word indicating a meaning of a word of less than a predetermined score. The instructions, when executed by the one or more processors individually or collectively, may further cause the electronic device to identify the word of less than the predetermined score as the predetermined word based on the user utterance voice; and obtain, based on the word of less than the predetermined score, the second word.

The memory may further store the LLM. The instructions, when executed by the one or more processors individually or collectively, may further cause the electronic device to input the prompt to the LLM; obtain response information based on the prompt; receive the user satisfaction with the response information; and update, based on the user satisfaction, the score.

The memory may further store the LLM. The score may be obtained based on first sample response information obtained by inputting each of a plurality of sample user utterance voices to the LLM, and second sample response information may be obtained by inputting plurality of sample prompts corresponding to the plurality of sample user utterance voices to the LLM.

The instructions, when executed by the one or more processors individually or collectively, may further cause the electronic device to change a word corresponding to the user command to an imperative type; and obtain the prompt.

The instructions, when executed by the one or more processors individually or collectively, may further cause the electronic device to identify, based on a type of the predetermined word and the first word, a location for the second word to be added in the user utterance voice.

The electronic device may further include a communication interface. The instructions, when executed by the one or more processors individually or collectively, may further cause the electronic device to control the communication interface to transmit the prompt to an external server and receive response information corresponding to the prompt from the external server through the communication interface.

According to an aspect of one or more embodiments of the present disclosure, a method of controlling an electronic device may include identifying a user command based on a user utterance voice; obtaining a first word indicating a location of at least one word that is a target of the user command based on the user utterance voice; obtaining, based on a predetermined word being identified from the user utterance voice, a second word explaining the predetermined word; and obtaining a prompt to be input to a large language model (LLM) based on the user utterance voice, the first word, and the second word.

The method may further include inputting the prompt to an LLM; and obtaining response information based on the prompt.

The obtaining of the second word may include identifying a word having multiple meanings as the predetermined word from the user utterance voice; and obtaining, based on the multiple meanings, the second word meant by the predetermined word in the user utterance voice.

The obtaining of the second word may include displaying a UI for selecting one of the multiple meanings; and obtaining, based on a selection of one of the multiple meanings, the second word.

The electronic device may store a score indicating user satisfaction with a plurality of words and the second word indicating a meaning of a word of less than a predetermined score. The obtaining of the second word may include identifying the word of less than the predetermined score as the predetermined word from the user utterance voice; and obtaining, based on the word of less than the predetermined score, the second word.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 is a block diagram illustrating a configuration of an electronic device according to one or more embodiments;

FIG. 2 is a block diagram illustrating a specific configuration of an electronic device according to one embodiment;

FIG. 3 is a view provided to explain a process of prompt processing according to one embodiment;

FIGS. 4 and 5 are views provided to explain a first word according to one embodiment;

FIGS. 6-8 are views provided to explain a method of processing a word having multiple meanings according to one embodiment;

FIGS. 9-11 are views provided to explain a method of processing a word of less than a predetermined score according to one embodiment; and

FIG. 12 is a flowchart provided to explain a control method of an electronic device according to one embodiment.

### DETAILED DESCRIPTION

Embodiments of the present disclosure provide an electronic device for performing prompt tuning before an input of a user utterance voice to a large language model, and a control method thereof.

Various embodiments set forth herein and terms used for the embodiments are not intended to limit the technical features of the matter of the disclosure to those of specific embodiments thereof, and it is to be understood that the embodiments set forth herein include various modifications, equivalents or alternatives thereof.

In describing the drawings, like reference numerals may be used to indicate like or relevant elements.

Unless explicitly stated otherwise, a singular form corresponding to an item may include a singular item or plural items.

In the disclosure, phrases such as “A or B,” “at least one of A and B,” “at least one of A or B,” “A, B or C,” “at least one of A, B and C,” and “at least one of A, B, or C” may respectively include any one or all possible combinations of the items listed together in the phrases.

In the disclosure, a term such as “1st,” “2nd,” or “first,” or “second” may be used merely to differentiate one element from another but not to limit the elements in another aspect (e.g., importance or order).

Based on one element (e.g., a first element) referred to as being “coupled with/to or connected with/to” another element (e.g., a second element) with or without the term “functionally” or “communicatively”, it is to be understood that one element may be connected to another element directly (e.g., in a wired manner), in a wireless manner, or through yet another element (e.g., a third element).

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Based on one element referred to as being “connected with/to,” “coupled with/to,” “supporting,” or “contacting” another element, it is to be understood that one element is connected with/to another element, is coupled with/to another element, supports another element, or contacts another element directly or indirectly through a third element.

Based on one element referred to as being placed “on” another element, it is to be understood that one element contacts another element and that yet another element is present between the two elements.

The term “and/or” includes a combination of a plurality of stated relevant elements or any of the plurality of stated relevant elements.

Further, unless stated otherwise or otherwise clear from context, phrase “based on” may refer to “based at least in part on” and not “based solely on.”

Hereafter, the operation mechanism and embodiments of the matter of the disclosure are described with reference to the drawings.

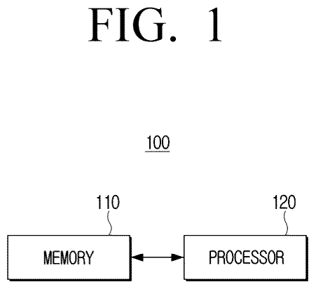

FIG. 1 is a block diagram illustrating a configuration of an electronic device 100 according to one embodiment.

The electronic device 100, as a device obtaining a prompt, may be implemented as a TV, a desktop PC, a laptop, a video wall, a large format display (LFD), a digital signage, a digital information display (DID), a projector display, a smartphone, a tablet PC, and the like. For example, the electronic device 100 may be a device that obtains a prompt from a user utterance or a text input and the like, and tunes the prompt. Alternatively, the electronic device 100 may be a device that receives a prompt from an external device, and tunes the prompt. Herein, the prompt, as one type of instruction message, may be information that is input to a large language model (LLM).

However, the electronic device 100 is not limited thereto, and is any device as long as the device obtains a prompt.

Referring to FIG. 1, the electronic device 100 includes memory 110 and a processor 120. However, the electronic device 100 may not be limited thereto, and implemented in the way that partial elements of the electronic device are excluded.

The memory 110 may refer to hardware storing information such as data and the like electrically magnetically such that the processor 120 and the like access the data. To this end, the memory 110 may be implemented as at least one hardware among non-volatile memory, volatile memory, flash memory, a hard disk drive (HDD), a solid state drive (SSD), RAM, ROM and the like.

The memory 110 may store at least one instruction for operations of the electronic device 100 or the processor 120. Herein, the instruction, as a code unit commanding the operations of the electronic device 100 or the processor 120, may be written in machine language that is a language understandable by a computer. Alternatively, the memory 110 may also store EDID and DPCD for the processor 120.

The memory 110 may store data that are information of a bit unit or a byte unit capable of representing a letter, a number, or an image and the like. For example, the memory 110 may store a user utterance voice, an LLM, a score indicating user satisfaction with each of a plurality of words, information on a meaning of a word of less than a predetermined score and the like.

The memory 110 may be accessed by the processor 120, and the processor 120 may perform reading/recording/correcting/deleting/updating and the like of an instruction, an instruction set, or data.

The processor 120 controls entire operations of the electronic device 100. For example, the processor 120 may be connected with each of the elements of the electronic device 100 and may control the entire operations of the electronic device 100. For example, the processor 120 may be connected with memory 110, a display (not illustrated) and the like, to control the operations of the electronic device 100.

The processor 120 may be implemented as one or more processors. At this time, the one or more processors may include one or more of a central processing unit (CPU), a graphics processing unit (GPU), an accelerated processing unit (APU), Many Integrated Core (MIC), a digital signal processor (DSP), a neural processing unit (NPU), a hardware accelerator or a machine learning accelerator. The one or more processors may control one among other elements of an electronic device 100 or any combination thereof, and perform an operation in association with communication or data processing. The one or more processors may execute one or more programs or instructions stored in memory 110. For example, the one or more processors may execute one or more instructions stored in the memory 110 to perform a method according to one embodiment of the disclosure.

In the case where the method according to one embodiment includes a plurality of operations, the plurality of operations may be performed by one processor or a plurality of processors. For example, when a first operation, a second operation, and a third operation are performed based on the method according to one embodiment, the first operation, the second operation and the third operation may all be performed by a first processor, or the first operation and the second operation may be performed by the first processor (e.g., a generic-purpose processor), while the third operation may be performed by a second processor (e.g., an AI-oriented processor). For example, a process of quantizing a neural network model according to one embodiment may be performed by the generic-purpose processor, or a process of training or inferring the quantized neural network model may be performed by the AI-oriented processor.

The one or more processors may be implemented as a single core processor including one core, or one or more multicore processors including a plurality of cores (e.g., a homogeneous multi core or a heterogeneous multi core). In the case where the one or more processors are implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or some of the plurality of cores) included in the multicore processor may read and perform a program instruction for implementing the method according to one embodiment independently, or may read and perform a program instruction for implementing the method according to one embodiment in the way that all (or part) of the plurality of cores are linked.

In the case where the method according to one embodiment includes a plurality of operations, the plurality of operations may be performed by one of the plurality of cores included in the multicore processor or performed by the plurality of cores included in the multicore processor. For example, when a first operation, a second operation, and a third operation are performed based on the method according to one embodiment, the first operation, the second operation and the third operation may all be performed by a first core included in the multicore processor, or the first operation and the second operation may be performed by the first core included in the multicore processor, while the third operation may be performed by a second core included in the multicore processor.

In the embodiments, the one or more processors may mean a system on a chip (SoC) where one or more processors and other electronic parts are integrated, a single core processor, a multicore processor, or a core included in a single core processor or a multicore processor, and herein, the core may be implemented as a CPU, a GPU, an APU, an MIC, a DSP an NPU, a hardware accelerator or a machine learning accelerator and the like, but embodiments thereof may not be limited thereto. Hereafter, the operations of the electronic device 100 may be described by using the processor 120 for convenience of description.

The processor 120 may identify a user command from a user utterance voice stored in the memory 110. For example, the processor 120 may identify user intent from the user utterance voice. Herein, the user utterance voice may be information stored in the memory 110, based on a user utterance. Alternatively, the user utterance voice may be information received from an external device.

The processor 120 may obtain, from a user utterance voice, a first word indicating the location of at least one word that is a target of a user command. For example, the processor 120 may identify, from a user utterance voice, at least one word that is a target of a user command, and obtain a first word such as “in the following descriptions” and the like indicating the location of the word.

The processor 120 may obtain, based on a predetermined word being identified from the user utterance voice, a second word explaining the predetermined word.

For example, the processor 120 may identify, from the user utterance voice, a word having multiple meanings as a predetermined word, and obtain, among the multiple meanings, a second word meant by the predetermined word in the user utterance voice. For example, the electronic device 100 may further include a display, and the processor 120 may control the display to display a UI for selecting one of the multiple meanings, and as one of the multiple meanings is selected, obtain a second word based on the selection.

The processor 120 may obtain, based on the user utterance voice, the first word and the second word, a prompt to be input to an LLM. For example, the processor 120 may add the first word and the second word to the user utterance voice to obtain a prompt. Additionally, the processor 120 may also change a word corresponding to a user command into an imperative type to obtain a prompt. Such an operation may be referred to as tuning of a prompt, and even in the case where each user makes an expression in a different way or a wrong way, a prompt securing improvement in the performance of an LLM may be obtained based on tuning of a prompt.

The memory 110 may further store an LLM, and the processor 120 may input a prompt to the LLM to obtain response information corresponding to the prompt. However, the LLM may not be limited thereto and may also be stored in an external server. In this case, the processor 120 may transmit the prompt to the external server, and receive, from the external server, the response information in which the prompt is processed and obtained by the LLM.

Above, the predetermined word as a word having multiple meanings is described as an example, but not be limited thereto. For example, the memory 110 may further store a score indicating user satisfaction with each of a plurality of words and a second word indicating the meaning of a word of less than a predetermined score, and the processor 120 may identify, from a user utterance voice, the word of less than a predetermined score as a predetermined word, and obtain a second word based on the word of less than a predetermined score. Herein, the score may be information that is obtained based on first sample response information obtained by inputting each of a plurality of sample user utterance voices to an LLM and second sample response information obtained by inputting each of a plurality of sample prompts corresponding to each of the plurality of sample user utterance voices to an LLM.

The processor 120 may input a prompt to an LLM to obtain response information corresponding to the prompt, receive user satisfaction with the response information and update a score based on the user satisfaction. By doing so, a prompt adaptive to the user may be obtained.

The processor 120 may identify, based on the type of predetermined word and the first word, a location for the second word to be added in the user utterance voice. For example, the processor 120 may add, based on the type of predetermined word being a word of less than a predetermined score in the user utterance voice and the first word being a word such as “in the following descriptions”, the second word to a start location of the user utterance voice. By doing so, the second word and the at least one word that is a target of the user command may be prevented from being mixed.

The processor 120 obtaining a first word and a second word is described above, but not limited thereto. For example, the processor 120 may also obtain at least one of a first word or a second word, and obtain a prompt to be input to an LLM based on the obtained word and a user utterance voice.

Additionally, the processor 120 may also obtain a second word and then obtain a first word.

A function associated with artificial intelligence (AI) according to the disclosure may be performed through the processor 120 and the memory 110.

The processor 120 may include of one processor or a plurality of processors. At this time, the one processor or the plurality of processors may be a generic-purpose processor such as CPU, AP, DSP and the like, a graphic-oriented processor such as GPU, Vision Processing Unit (VPU), or an AI-oriented processor such as NPU.

The one processor or the plurality of processors may perform control to process input data, according to a predefined operation rule or an AI model that is stored in the memory 110. Alternatively, in the case where the one processor or the plurality of processors are an AI-oriented processor, the AI-oriented processor may be designed in a hardware structure specializing in processing of a specific AI model. The predetermined operation rule or the AI model is characterized in that the predetermined operation rule or the AI model is made based on training.

Herein, making the predefined operation rule or the AI model based on learning means making a predefined operation rule or an AI model that is set to achieve a desired feature (or aim) by training a foundation AI model with large numbers of learning data based on a learning algorithm. Such learning may be performed in an apparatus itself in which AI according to the disclosure is performed, or performed through a separate server/system. The learning algorithm, for example, includes supervised learning, unsupervised learning, semi-supervised learning or reinforcement learning, but is not limited to the above examples.

The AI model may include a plurality of neural network layers. Each of the plurality of neural network layers has a plurality of weights, and performs neural network computation based on computation results of a previous layer and computation among the plurality of weights. The plurality of weights possessed by the plurality of neural network layers may be optimized based on training results of the AI model. For example, the plurality of weights may be updated such that a loss value or a cost value obtained from the AI model may be decreased or minimized during a training process.

An artificial neural network may include a deep neural network (DNN), and for example, may include a convolutional neural network (CNN), a deep neural network (DNN), a recurrent neural network (RNN), a restricted boltzmann machine (RBM), a deep belief network (DBN), a bidirectional recurrent deep neural network (BRDNN), a generative adversarial network (GAN), transformer neural network, or a deep Q-network and the like, but not be limited thereto.

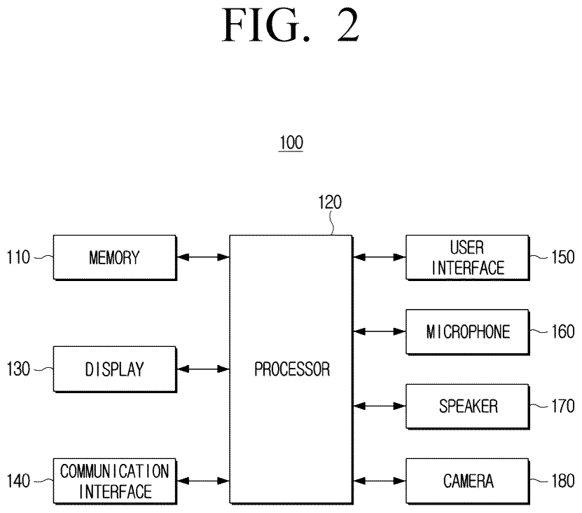

FIG. 2 is a block diagram illustrating a specific configuration of an electronic device 100 according to one embodiment. An electronic device 100 may include memory 110 and a processor 120. The electronic device 100 may further include a display 130, a communication interface 140, a user interface 150, a microphone 160, a speaker 170 and a camera 180. Among the elements illustrated in FIG. 2, detailed descriptions of elements overlapping with the elements illustrated in FIG. 1 are omitted.

The display 130 as an element displaying contents may be implemented as various types of displays such as a liquid crystal display (LCD), an organic light emitting diode (OLED) display, a plasma display panel (PDP) and the like. In the display 130, driving circuitry implementable in the form of an a-si TFT, a low temperature poly silicon (LTPS) TFT, an organic TFT (OTFT) and the like, a backlight unit, and the like may be included together. The display 130 may be implemented as a touch screen coupled with a touch sensor, a flexible display, a three-dimensional (3D) display, and the like.

The communication interface 140 is an element performing communication with various types of external devices based on various communication methods. For example, the electronic device 100 may perform communication with an external server through the communication interface 140.

The communication interface 140 may include a Wi-Fi module, a Bluetooth module, an infrared communication module and the like. Herein, each of the communication modules may be implemented in the form of at least one hardware chip.

Unless explicitly described or implicitly understood from one or more embodiments of the present disclosure, at least one of the components, elements, modules, units, or nominalized verbs represented by a block or equivalent indication in the drawings may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation. In other examples, the at least one processor may be implemented as an application-specific integrated circuit (ASIC) or field-programmable gate array (FPGA).

The Wi-Fi module, the Bluetooth module perform communication based on a Wi-Fi method, a Bluetooth method respectively. In the case where the Wi-Fi module or the Bluetooth module is used, various types of connection information such as an SSID, a session key and the like may be first transmitted and received, and are used to perform a communication connection and then transmit and receive various types of information. The infrared communication module performs communication based on an infrared Data Association (IrDA) communication technology which transmits data wirelessly over a short distance by using infrared rays between optical (visible) light and millimeter waves.

A wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like, in addition to the above communication methods.

Alternatively, the communication interface 140 may include a wired communication interface such as HDMI, DP, Thunderbolt, USB, RGB, D-SUB, DVI and the like.

In addition, the communication interface 140 may also include at least one among wired communication modules that perform communication by using a local area network (LAN) module, an Ethernet module, or pair cables, coaxial cables, or fiber optic cables and the like.

The user interface 150 may be implemented as a button, a touch pad, a mouse, a keyboard and the like, or as a touch screen capable of performing a display function and a manipulation input function together. Herein, the button may be various types of buttons such as a mechanical button, a touch pad, a wheel and the like that are formed in any area of the front, side, rear and the like of the exterior of the main body of the electronic device 100.

The microphone 160 is an element receiving, as an input, a sound and converting the sound into an audio signal. The microphone 160 may be connected with the processor 120 electrically, and may receive a sound under the control of the processor 120.

For example, the microphone 160 may be formed integrally in directions of an upper side, a front surface, or a side surface and the like of the electronic device 100. Alternatively, the microphone 160 may also be provided in a remote controller and the like, separate from the electronic device 100. In this case, the remote controller as a separate device may also receive a sound through the microphone 160 and provide the received sound to the electronic device 100.

The microphone 160 may include various types of elements such as a microphone collecting a sound in an analog form, amplification circuitry amplifying the collected sound, and A/D converter circuitry sampling the amplified sound and converting the amplified sound into a digital signal, filter circuitry removing noise components from the converted digital signal, and the like.

The microphone 160 may be implemented in the form of a sound sensor, but may be implemented in any form as long as the microphone collects a sound.

The processor 120 may receive a user utterance voice through the microphone 160.

The speaker 170 is an element outputting various types of notification sounds or voice messages and the like as well as various types of audio data processed by the processor 120.

The camera 180 is an element for capturing a still image or a moving image. The camera 180 may capture a still image at a specific timepoint, but may capture a still image continuously. The camera 180 may capture an image of at least one direction of the electronic device 100.

The camera 180 includes a lens, a shutter, an aperture, a solid-state imaging device, an analog front end (AFE) and a timing generator (TG). The shutter adjusts time taken for light reflected from a subject to come into the camera 180, and the aperture adjusts an amount of light input to the lens by mechanically increasing or decreasing the size of an opening into which light comes. In the case where light reflected from a subject is accumulated as photocharges, the solid-state imaging device outputs an image formed by the photocharges as an electrical signal. The TG outputs a timing signal for reading out pixel data of the solid-state imaging device, and the AFE samples and digitizes an electrical signal output from the solid-state imaging device.

As described above, the electronic device 100 may tune the prompt from the user utterance voice and provide the tuned prompt to the LLM, thereby making it possible to obtain response information further improved than that without tuning.

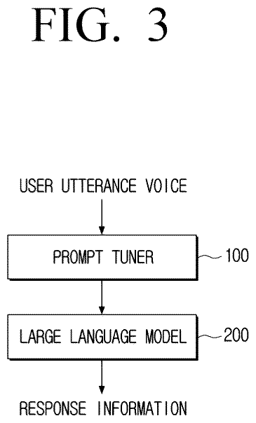

Hereafter, the operations of the electronic device 100 are described in greater detail with reference to FIGS. 3-11. Regarding FIGS. 3-11, individual embodiments are described for convenience of description. However, the individual embodiments of FIGS. 3-11 may also be implemented in any other combined state or in any different order. In particular, regarding FIGS. 3-11, a prompt updated step by step is described for convenience of description, but the steps may be changed in any other way and performed individually.

FIG. 3 is a view provided to explain a process of prompt processing according to one embodiment.

The electronic device 100, as illustrated in FIG. 3, may be referred to as a prompt tuner, and the processor 120 may obtain a prompt from a user utterance voice.

An external server 200 may store an LLM, and input the prompt provided by the electronic device 100 to the LLM to obtain response information.

Since the prompt is in the state where the prompt is tuned by the electronic device 100, response information clearer than that without tuning may be generated. For example, a user utterance voice including multiple meanings may be interpreted to have a meaning not intended by the user in an LLM, but the prompt having tackled the multiple meanings may be interpreted to have a meaning intended by the user, thereby making it possible to output more proper response information.

Regarding FIG. 3, the electronic device 100 and the external server 200 are described as a separate element for convenience of description, but not limited thereto. For example, the electronic device 100 may also store an LLM, obtain a prompt from a user utterance voice, and then input the obtained prompt to the LLM to obtain response information.

Although shown as separate elements in FIGS. 1-3, one or more of these components may be integrated into a single component, or conversely, a single component may be implemented as multiple discrete elements. Additionally, different subsets of the illustrated components may be combined in various configurations.

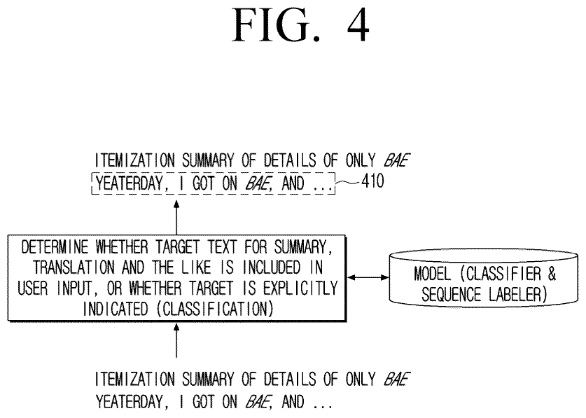

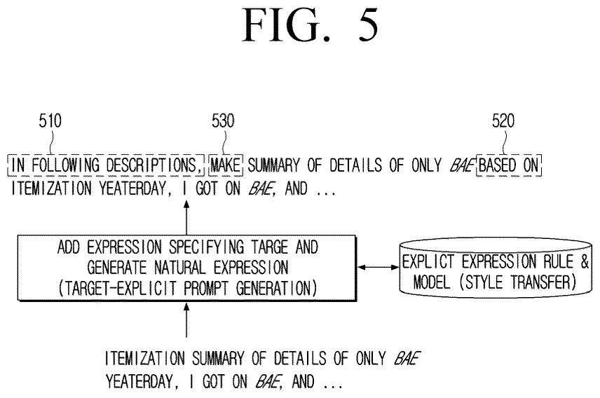

FIGS. 4 and 5 are views provided to explain a first word according to one embodiment.

The processor 120 may obtain, from a user utterance voice, a first word indicating the location of at least one word that is a target of a user command.

For example, the processor 120 may identify, through a classifier, whether a target text is present from the user utterance voice, and identify, through a sequence labeler, whether a target is expressed explicitly. For example, the processor 120, as illustrated in FIG. 4, may identify, as at least one word that is a target of a user command “summary”, “Yesterday, I got on a bae, and . . . (410)” from a user utterance voice such as “itemization summary of details of only bae. Yesterday, I got on a bae, and . . . ”.

The processor 120 may obtain, based on relative locations of the user command and the target of the user command, a first word from the user utterance voice. For example, the processor 120, as illustrated in FIG. 5, may obtain “in the following descriptions (510)” as the first word since the expression “summary” is followed by “Yesterday, I got on a bae, and . . . ”.

The processor 120 may obtain, based on the user utterance voice and the first word, a prompt to be input to an LLM. Herein, the processor 120 may add, based on the location of the target of the user command, the first word to the user utterance voice. For example, the processor 120 may add “in the following descriptions (510)” before the expression “Yesterday, I got on a bae, and . . . ”.

The processor 120 may modify the user utterance voice through a style transfer in a natural manner. For example, the processor 120, as illustrated in FIG. 5, may add “based on (52-0)” and “make (530)” to change “itemization summary” to “make a summary based on itemization” to update the prompt.

A model such as a classifier and the like in FIGS. 4 and 5 may be implemented as a rule base, or in the form of a neural network model.

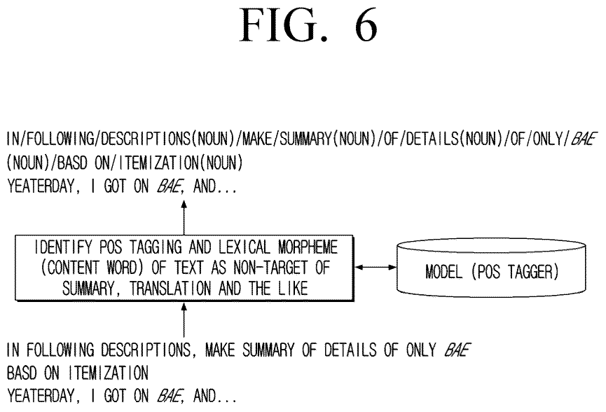

FIGS. 6-8 are views provided to explain a method of processing a word having multiple meanings according to one embodiment.

The processor 120 may obtain, based on a predetermined word being identified from a user utterance voice, a second word explaining the predetermined word.

For example, the processor 120 may identify, as a predetermined word, a word having multiple meanings from a user utterance voice, and obtain, among the multiple meanings, a second word meant by the predetermined word in the user utterance voice. For example, the processor 120, as illustrated in FIG. 6, may identify a lexical morpheme such as a noun, a verb, an adjective, an adverb and the like from the user utterance voice through a Part-of-Speech (POS) tagger, and identify “bae” as a word have multiple meanings.

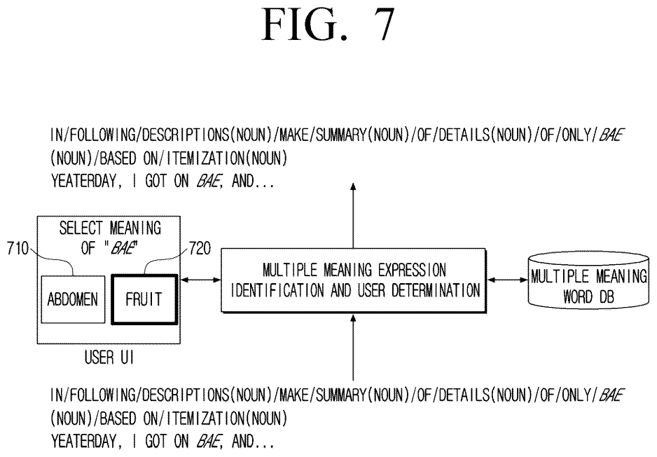

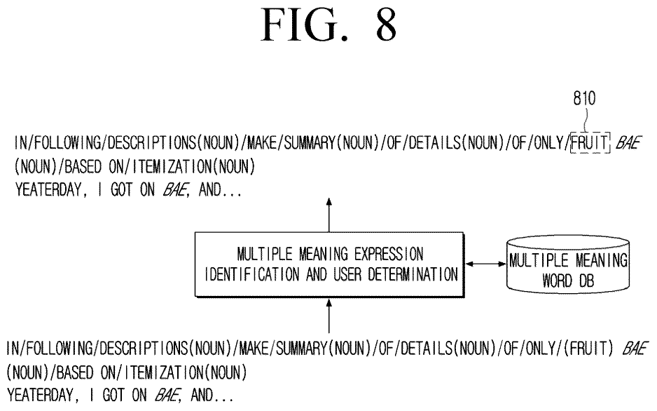

The processor 120, as illustrated in FIG. 7, may display a UI for selecting an “abdomen (710)” or a “fruit (720)” as the “bae”, and may add, based on “fruit (720)” being selected, “fruit (810)” before “bae” as the second word, as illustrated in FIG. 8, to update a prompt.

A model such as a POS tagger in FIGS. 6-8 may be implemented as a rule base, or in the form of a neural network model.

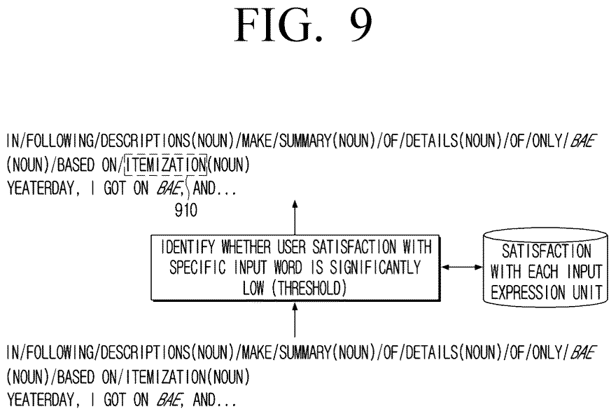

FIGS. 9-11 are views provided to explain a method of processing a word of less than a predetermined score according to one embodiment.

The processor 120 may also identify a word of less than a predetermined score as a predetermined word from a user utterance voice, and based on the word of less than a predetermined score, obtain a second word. For example, the memory 110 may further store a score indicating user satisfaction with each of a plurality of words, and a second word indicating the meaning of the word of less than a predetermined score, and the processor 120 may identify, based on information stored in the memory 110, a word of less than a predetermined score as a predetermined word from a user utterance voice, and obtain a second word indicating the meaning of the word of less than a predetermined score. For example, the processor 120, as illustrated in FIG. 9, may identify “itemization (910)” as the word of less than a predetermined score.

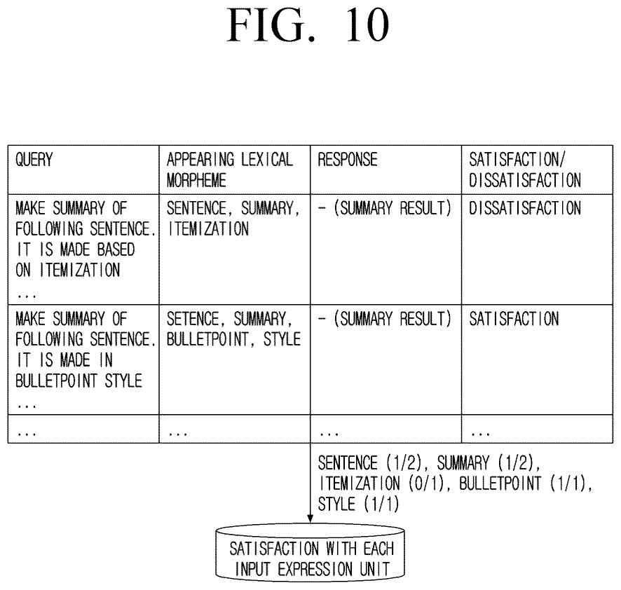

Herein, the score may be obtained based on first sample response information obtained by inputting each of a plurality of sample user utterance voices to an LLM and second sample response information obtained by inputting each of a plurality of sample prompts corresponding to each of the plurality of sample user utterance voices to an LLM. For example, the score, as illustrated in FIG. 10, may also be obtained based on user evaluations with respect to the sample response information obtained by inputting each of plurality of sample prompts corresponding to each of the plurality of sample user utterance voices to the LLM. In the case where the user is dissatisfied, the score of each lexical morpheme included in a sample prompt may be decreased by a predetermined value. As such an operation is repeated a few times, a lexical morpheme in question may have a score significantly less than that of another lexical morpheme, and with respect to a word of less than a predetermined score, information indicating the meaning of the word may be stored in the memory 110.

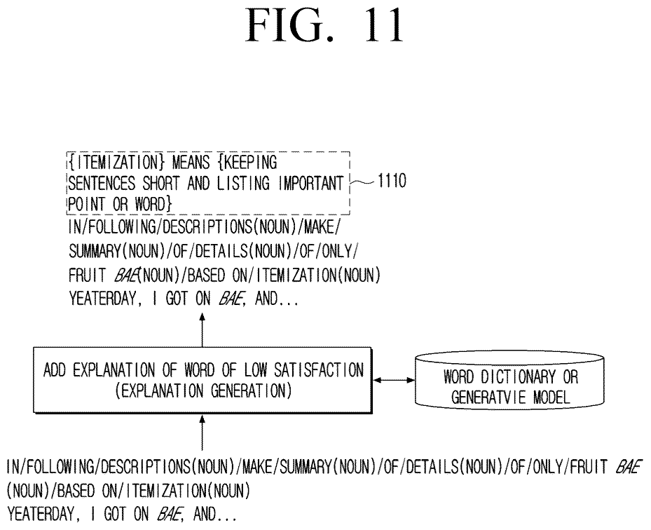

The processor 120, as illustrated in FIG. 11, may add, to the user utterance voice, “{itemization} indicating the meaning of “itemization (910)” as a word of less than a predetermiend score through a disctionary or a generative model means {keeping sentences short and listing an important point or word for writing} (1110)” as a second word.

Herein, the processor 120 may identify, based on the type of predetermined word and the first word, the location for the second word to be added in the user utterance voice. In some examples, the processor 120 may identify, based on the locations of the word of less than a predetermined score and at least one word as a target of a user command, the location for the second word indicating the meaning of the word of less than a predetermined score to be added. In the above example, the second word may be added before the at least one word as a target of a user command based on the first word such as “in the following descriptions”.

The processor 120 may input a prompt to an LLM to obtain response information corresponding to the prompt, receive user satisfaction with respect to the response information, and update a score based on the user satisfaction. For example, in the case where the user is dissatisfied, the processor 120 may decrease the score of each lexical morpheme included in the prompt by a predetermined value. As such an operation is repeated, the processor 120 may further store, based on the score of a specific word being decreased to a score less than a predetermined score, the meaning of the specific word in the memory 110.

A model such as a dictionary or a generative model in FIGS. 9-11 may be implemented as a rule base, or in the form of a neural network model.

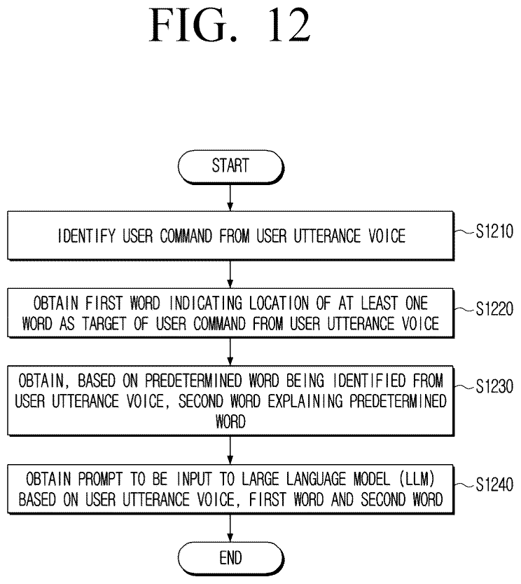

FIG. 12 is a flowchart provided to explain a control method of an electronic device according to one embodiment.

The method includes identifying a user command from a user utterance voice (S1210). Additionally, the method includes obtaining a first word indicating the location of at least one word that is a target of the user command from the user utterance voice (S1220). Additionally, the method includes obtaining, based on a predetermined word being identified from the user utterance voice, a second word explaining the predetermined word (S1230). Additionally, the method includes obtaining, based on the user utterance voice, the first word and the second word, a prompt to be input to an LLM (S1240).

Additionally, the method may further include inputting the prompt to a large language model to obtain response information corresponding to the prompt.

Additionally, the obtaining a second word (S1230) may include identifying a word having multiple meanings as a predetermined word from the user utterance voice, and obtaining, among the multiple meanings, a second word meant by the predetermined word in the user utterance voice.

Additionally, the obtaining a second word (S1230) may include displaying a UI for selecting one of the multiple meanings, and as one of the multiple meanings is selected, obtaining a second word based on the selection.

Additionally, an electronic device may store a score indicating user satisfaction with each of a plurality of words and a second word indicating the meaning of a word of less than a predetermined score, and the obtaining a second word (S1230) may include identifying the word of less than a predetermined score as a predetermined word from the user utterance voice, and obtaining, based on the word of less than a predetermined score, a second word.

Additionally, the method may further include inputting a prompt to an LLM and obtaining response information corresponding to the prompt, receiving user satisfaction with the response information, and updating a score based on the user satisfaction.

Additionally, the score may be obtained based on first sample response information obtained by inputting each of a plurality of sample user utterance voices to the LLM and second sample response information obtained by inputting each of a plurality of sample prompts corresponding to each of the plurality of sample user utterance voices to the LLM.

Additionally, the obtaining a prompt (S1240) may include changing a word corresponding to the user command to an imperative type and obtaining a prompt.

Further, the obtaining a prompt (S1240) may include identifying, based on the type of predetermined word and the first word, a location for the second word to be added in the user utterance voice.

Furthermore, the method may further include transmitting the prompt to an external server and receiving response information corresponding to the prompt from the external server.

According to the above embodiments, the electronic device may tune a prompt from a user utterance voice and provide the tuned prompt to a large language model, making it possible to obtain response information further improved than that without tuning.

The embodiments described above may be implemented with software including instructions stored in a storage medium readable by a machine (e.g., a computer). The machine, as a device capable of calling the stored instructions from the storage medium and operating according to the called instructions, may include an electronic device (e.g., electronic device A) according to the disclosed embodiments. Based on the instructions being executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium does not include a signal and that the storage medium is tangible, while the term does not differentiate semi-permanent or temporary storage of data in the storage medium.

According to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In the case of online distribution, at least part of the computer program product may be stored at least temporarily, or may be generated temporarily in a storage medium such as a manufacturer's server, a server of an application store, or memory of a relay server.

Additionally, the embodiments described above may be implemented in a recording medium readable by a computer or a device similar to a computer by using software, hardware or a combination thereof. In some cases, the embodiments set forth herein may be implemented as a processor itself. In the case of software implementation, the embodiments such as steps and functions described herein may be implemented with separate software. The software may respectively perform one or more functions and operations set forth herein.

Computer instructions for performing processing operations of the device according to the embodiments described above may be stored in a non-transitory computer-readable medium. The computer instructions stored in the non-transitory computer-readable medium, when executed by a processor of a specific device, cause the device to perform the processing operations in the device according to the embodiments described above. The non-transitory computer-readable medium means a medium that stores data semi-permanently and is readable by a machine, rather than a medium such as a register, cache, and memory and the like that store data temporarily. Specific examples of the non-transitory computer-readable medium may include a CD, a DVD, a hard disc, a blue-ray disc, a USB, a memory card, and ROM and the like.

Further, each of the elements (e.g., modules or programs) according to the embodiments described above may include a single entity or a plurality of entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to the integration, in an identical way or a similar way. Operations performed by a module, a program, or another element, according to the embodiments, may be executed sequentially, in parallel, repetitively, or heuristically, or at least some of the operations may be executed in a different order, omitted, or include another operation. While example embodiments of the disclosure are illustrated and described above, embodiments of the disclosure are not limited to specific embodiments set forth herein, and certainly, various modifications thereof may be made by those skilled in the art, without departing from the matter of the disclosure, claimed in the section of claims, and should not be understood as separating from the technical spirit or prospect of the disclosure.

What is claimed is:

1. An electronic device comprising:
memory storing instructions; and
one or more processors comprising processing circuitry,
wherein the instructions, when executed by the one or more processors individually or collectively, cause the electronic device to:
identify a user command based on a user utterance voice stored in the memory;
obtain a first word indicating a location of at least one word that is a target of the user command based on the user utterance voice;
obtain, based on a predetermined word being identified from the user utterance voice, a second word explaining the predetermined word; and
obtain a prompt to be input to a large language model (LLM) based on the user utterance voice, the first word, and the second word.

2. The electronic device of claim 1,
wherein the memory further stores the LLM, and
wherein the instructions, when executed by the one or more processors individually or collectively, further cause the electronic device to:
input the prompt to the LLM; and
obtain response information corresponding to the prompt.

3. The electronic device of claim 1,
wherein the instructions, when executed by the one or more processors individually or collectively, further cause the electronic device to:
identify a word having multiple meanings as the predetermined word based on the user utterance voice; and
obtain, among the multiple meanings, the second word meant by the predetermined word in the user utterance voice.

4. The electronic device of claim 3, further comprising:
a display,
wherein the instructions, when executed by the one or more processors individually or collectively, further cause the electronic device to:
control a display to display a user interface (UI) for selecting one of the multiple meanings; and
obtain, based on a selection of one of the multiple meanings, the second word.

5. The electronic device of claim 1,
wherein the memory further stores a score indicating user satisfaction with a plurality of words and the second word indicating a meaning of a word of less than a predetermined score, and
wherein the instructions, when executed by the one or more processors individually or collectively, further cause the electronic device to:
identify the word of less than the predetermined score as the predetermined word based on the user utterance voice; and
obtain, based on the word of less than the predetermined score, the second word.

6. The electronic device of claim 5,
wherein the memory further stores the LLM, and
wherein the instructions, when executed by the one or more processors individually or collectively, further cause the electronic device to:
input the prompt to the LLM;
obtain response information based on the prompt;
receive the user satisfaction with the response information; and
update, based on the user satisfaction, the score.

7. The electronic device of claim 5,
wherein the memory further stores the LLM, and
wherein the score is obtained based on first sample response information obtained by inputting each of a plurality of sample user utterance voices to the LLM, and second sample response information is obtained by inputting plurality of sample prompts corresponding to the plurality of sample user utterance voices to the LLM.

8. The electronic device of claim 1,
the instructions, when executed by the one or more processors individually or collectively, further cause the electronic device to:
change a word corresponding to the user command to an imperative type; and
obtain the prompt.

9. The electronic device of claim 1,
wherein the instructions, when executed by the one or more processors individually or collectively, cause the electronic device to:
identify, based on a type of the predetermined word and the first word, a location for the second word to be added in the user utterance voice.

10. The electronic device of claim 1, further comprising:
a communication interface,
wherein the instructions, when executed by the one or more processors individually or collectively, further cause the electronic device to:
control the communication interface to transmit the prompt to an external server and receive response information corresponding to the prompt from the external server through the communication interface.

11. A method of controlling an electronic device, the method comprising:
identifying a user command based on a user utterance voice;
obtaining a first word indicating a location of at least one word that is a target of the user command based on the user utterance voice;
obtaining, based on a predetermined word being identified from the user utterance voice, a second word explaining the predetermined word; and
obtaining a prompt to be input to a large language model (LLM) based on the user utterance voice, the first word, and the second word.

12. The method of claim 11 further comprising:
inputting the prompt to an LLM; and
obtaining response information based on the prompt.

13. The method of claim 11, wherein the obtaining of the second word comprises:
identifying a word having multiple meanings as the predetermined word from the user utterance voice; and
obtaining, based on the multiple meanings, the second word meant by the predetermined word in the user utterance voice.

14. The method of claim 13, wherein the obtaining of the second word further comprises:
displaying a UI for selecting one of the multiple meanings; and
obtaining, based on a selection of one of the multiple meanings, the second word.

15. The method of claim 11,
wherein the electronic device stores a score indicating user satisfaction with a plurality of words and the second word indicating a meaning of a word of less than a predetermined score, and
wherein the obtaining of the second word comprises:
identifying the word of less than the predetermined score as the predetermined word from the user utterance voice; and
obtaining, based on the word of less than the predetermined score, the second word.
